(19) United States
(12) Patent Application Publication
(10) Pub. No.: US 2008/0307308 A1
(43) Pub. Date: Dec. 11, 2008

(54) Creating Web Clips

(75) Inventors: John Sullivan, Pacific Grove, CA (US); Kevin Decker, San Jose, CA (US); Bertrand Serlet, Palo Alto, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/760,658

(22) Filed: Jun. 8, 2007

(51) Int. Cl. G06F 3/01

(52) U.S. Cl. 715/723

(57) ABSTRACT

Methods, computer program products, systems and data structures are described to assist a user in identifying a number of potential areas of interest and selecting an area of interest suitable for clipping as the user navigates around a content source. In some implementations, the content source can be parsed and evaluated to identify one or more structural elements that may contain one or more potential areas of interest. The identified elements are then presented to the user.

### TECHNICAL FIELD

This invention relates to selecting content for presentation to users.

### BACKGROUND

Existing computer systems allow a user to clip an item of interest, such as a block of text, from a first document into a clipboard. The user may then paste the contents of the clipboard into a second document. If the user becomes aware that the item of interest has been modified in the first document, the user may again clip the now-modified item of interest from the first document, and re-paste the now-modified clipboard portion into the second document.

Common browsers allow a user to select a web page, and to further select an area of interest in the web page for display by scrolling until the area of interest displays in the browser's display window. If the user desires to have the browser display the most current content in the selected area of interest in the web page, the user may manually request a refresh of the web page. After closing the browser, if the user again desires to view the area of interest, the user may launch the browser and repeat the process of selecting the area of interest.

### SUMMARY

Methods, computer program products, systems and data structures are described to assist a user in identifying a number of potential areas of interest and selecting an area of interest suitable for clipping as the user navigates around a content source. In some implementations, the content source can be parsed and evaluated to identify one or more structural elements that may contain one or more potential areas of interest. The identified elements are then presented to the user

In one aspect, a method is provided that includes receiving input to select a portion of a document corresponding to an area of interest associated with a clipping; identifying a structural element associated with the portion; determining a boundary associated with the structural element; and triggering a visual impression indicating the structural element.

One or more implementations can optionally include one or more of the following features. The method can include triggering a visual impression in proximity to a boundary. The method also include receiving input to adjust a size of a boundary, wherein triggering a visual impression in proximity to the boundary includes triggering the visual impression in proximity to the adjusted boundary. The method further can include receiving further input and responsive thereto removing a visual impression indicating a structural element; receiving input to select another structural element in a document; and displaying the another structural element with the visual impression. The method further can include highlighting a structural element.

In another aspect, a method is provided that includes providing a user interface for presentation on a display device, the user interface including a display area for display content; identifying one or more structural elements in the content displayed in the display area, at least one structural element being associated with a potential area of interest; and displaying the identified structural elements with a visual impression.

In yet another aspect, a method is provided that includes identifying a content source; identifying one or more elements in the content source, the one or more elements having a corresponding structure in the content source; determining one or more potential areas of interest based on the one or more identified elements, the one or more potential areas being displayed in a display area; identifying a boundary for each of the one or more potential areas of interest; presenting the one or more potential areas of interest; and triggering a visual effect in proximity to the boundary based on a predetermined criteria.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram showing an example clipping application.

FIG. 2 shows a web page having multiple example structural elements.

FIG. 3 is a flow chart showing an example process for creating a clipping of content.

FIG. 4 is a flow chart showing an example for determining one or more potential areas of interest in a content source.

FIG. 5 is a flow chart showing an example process for effectuating a visual effect on a structural element.

FIG. 6A is a screen shot showing a browser.

FIG. 6B is a screen shot showing example coordinates of a structural element.

FIG. 7 is a screen shot showing a potential area of interest.

FIG. 8 is a screen shot showing another potential area of interest.

FIG. 9 is a screen shot showing a lock-down mechanism.

FIG. 10 is a screen shot showing an example web clipping being resized and repositioned.

FIG. 11 is a screen shot showing a completed widget.

FIG. 12 is a screen shot showing a preference window for choosing a display theme for the completed widget.

FIG. 13 is a block diagram showing a system for clipping content.

Like reference symbols in the various drawings indicate like elements.

### DETAILED DESCRIPTION

### Clipping Application Components

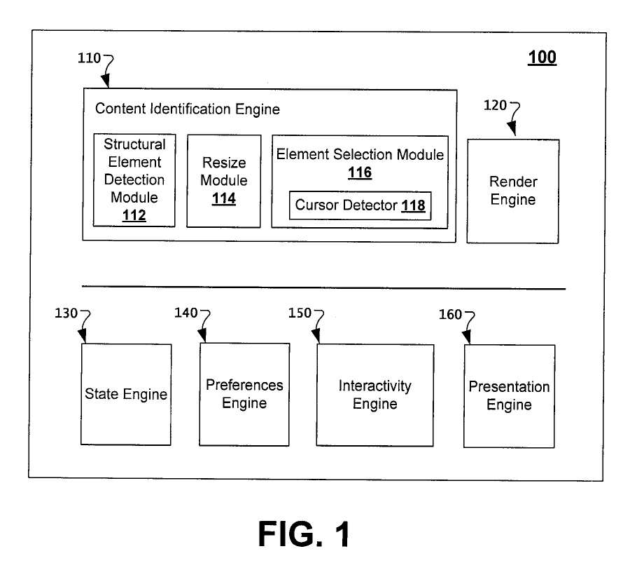

Referring to FIG. 1, components of a clipping application 100 are shown. Clipping application 100 provides functionality for clipping content and presenting the clipped content or clippings to a user. Clipping application 100 generally includes a content identification engine 110 for identifying content to be clipped, a render engine 120 for rendering content, a state engine 130 for enabling a refresh of the clipped content, a preferences engine 140 for setting preferences associated with, for example, the display and configuration of the clipped content, an interactivity engine 150 for processing interactions between a user and the clipped content, and a presentation engine 160 for presenting the clipped content to a user. Engines 110-160 can be communicatively coupled to one or more of each other. Though the engines identified above are described as being separate or distinct, one or more of the engines may be combined in a single process or routine. The functional description provided herein including separation of responsibility for distinct functions is by way of example. Other groupings or other divisions of functional responsibilities can be made as necessary or in accordance with design preferences.

Clipping application 100 can be a lightweight process that uses, for example, objects defined as part of a development environment such as the Cocoa Application Framework (as referred to as the Application Kit or AppKit, described for example at Mac OS X Tiger Release Notes Cocoa Application Framework, available from Apple® Computer Inc. Clippings produced by clipping application 100 can be implemented in some instantiations as simplified browser screens that omit conventional interface features such as menu bars, window frame, and the like.

### Content Identification Engine

Content identification engine 110 may be used to initially identify content to be clipped from a content source. A content source can be, without limitation, a file containing images, text, graphics, forms, music, and videos. A content source can also include a document having any of a variety of formats, files, pages and media, an application, a presentation device or inputs from hardware devices (e.g., digital camera, video camera, web cam, scanner, microphone, etc.).

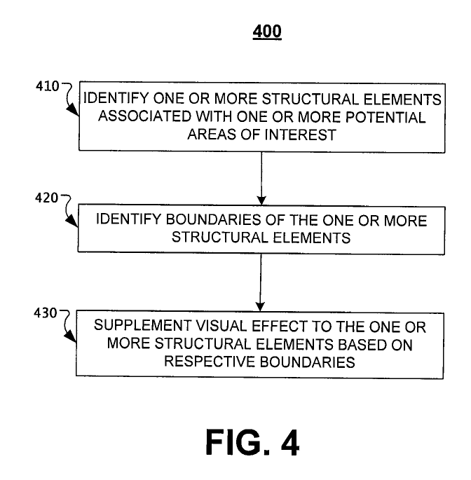

In some implementations, upon activation, the content identification engine 110 can automatically identify and highlight default content in the content source, the process of which will be described in further detail below with respect to FIGS. 4, 7-11. Alternatively, the process of identifying particular content to be clipped may include receiving a clipping request from the user, and manually selecting and confirming content to be clipped.

In clipping content from a content source, the content identification engine 110 may obtain information about the content source (e.g., identifier, origin, etc.) from which the content was clipped as well as configuration information about the presentation tool (e.g., the browser) used in the clipping operation. Such configuration information may be required to identify an area of interest within the content source. An area of interest can represent a contiguous area of a content source, such as a frame or the like, or can be an accumulation of two or more non-contiguous or unrelated pieces of content from a single or multiple sources.

As an example, when a web page (e.g., one form of a content source) is accessed from a browser, the configuration of the browser (e.g. size of the browser window) can affect how content from the web page is actually displayed (e.g., page flow, line wrap, etc.), and therefore which content the user desires to have clipped.

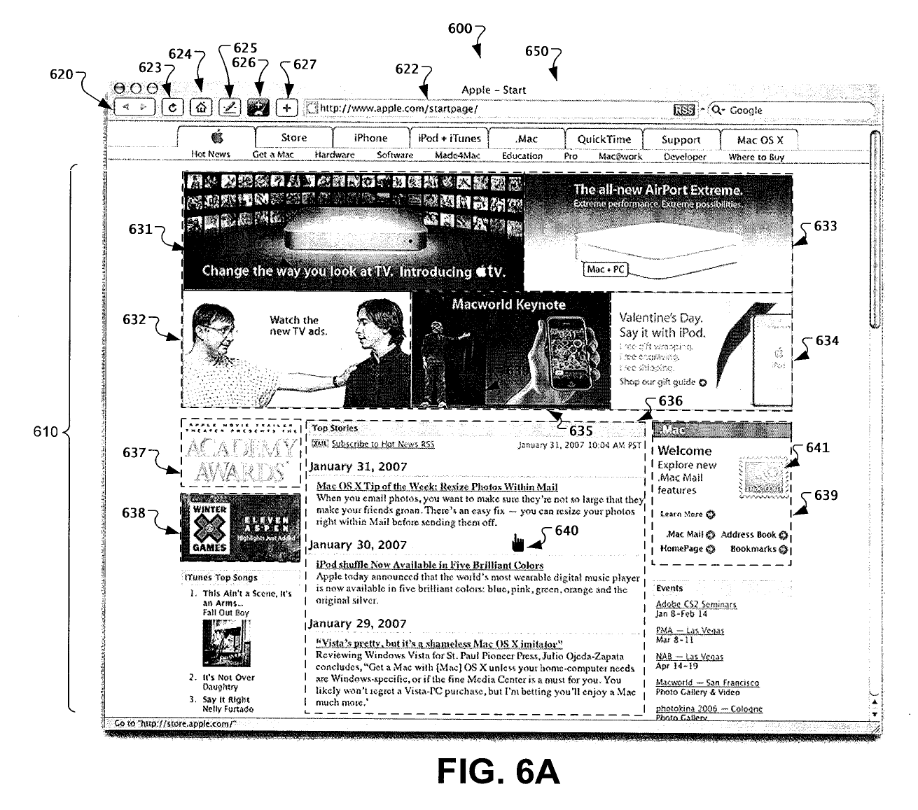

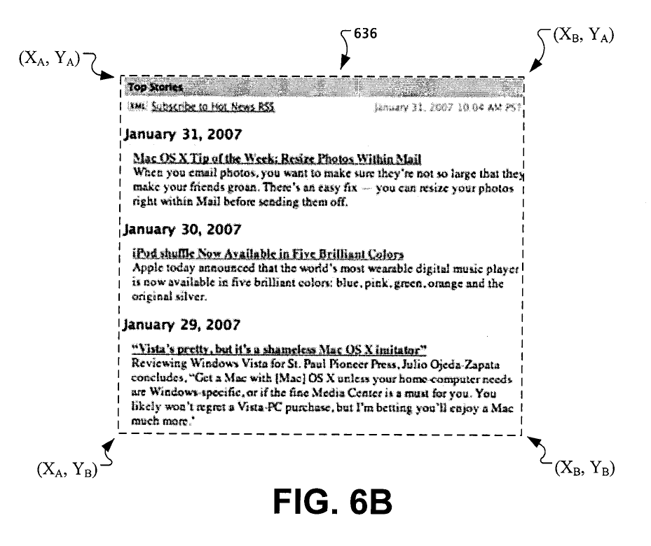

The content identification engine 110 also can function to access a previously selected area of interest during a refresh of the clipped content. Identifying content or accessing a previously identified area of interest can include numerous operations that may be performed, in whole or in part, by the content identification engine 110, or may be performed by another engine such as one of engines 110-160. FIGS. 6-12 discusses many of the operations that may be performed, for example, in creating a clipping of content, and the content identification engine 110 may perform various of those and other operations. For example, the content identification engine 110 may identify a content source, enable a view to be presented, such as a window, that displays the content source, enable the view to be shaped (or reshaped), sized (or resized) and positioned (or repositioned), and enable the content source(s) to be repositioned within the view to select or navigate to an area of interest in which the desired content to be clipped resides.

Enabling a view to be presented may include, for example, identifying a default (or user specified) size, shape and screen position for a new view, accessing parameters defining a frame for the new view including position, shape, form, size, etc., accessing parameters identifying the types of controls for the new view, as well as display information for those controls that are to be displayed, with display information including, for example, location, color, and font, and presenting the new view.

Further, as will be discussed in more detail below, the content identification engine 110 may be initialized in various ways, including, for example, by receiving a user request to clip content, by receiving a user's acceptance of a prompt to create a clipping, or automatically.

The content identification engine 110 also can evaluate the content source to identify structural elements within the content source to determine the content to be clipped. The evaluation can include determining a number of structural elements and their respective locations in the content source including boundaries, as will be described in greater detail below with respect to the structure element detection module 112.

### Structural Element Detection Module

Structural element detection module 112 can be used to parse and evaluate a content source, and the result of which can be used to identify one or more structural elements (e.g., a column of text, a paragraph, a table, a chart and the like) within the content source. For example, the structural element detection module 112 can parse a web page (e.g., one form of a content source) to determine one or more document sections, tables, graphs, charts, and images in a content source as well as their respective spatial locations in the content source.

Elements in the content source are generally expressed in a document object model (DOM), a hierarchy of elements, which contains some elements that are structural and some that are not. In some implementations, the structural element detection module 112 can utilize the DOM to determine which of the elements are structural and which structural elements can potentially be used for clipping purposes.

Such structural elements, once identified, may be useful, for example, in assisting the user in quickly identifying one or more potential areas of interest without being distracted by irrelevant materials presented in the web page. As an example, potential areas of interest defined by the structural elements can include content associated with, for example, weekly editorial, live box scores, daily horoscope, or breaking news. Each element identified as a structural element by the structural element detection module 112 can be automatically and individually indicated to the user, for example, by using a visual effect, as will be described in greater detail below.

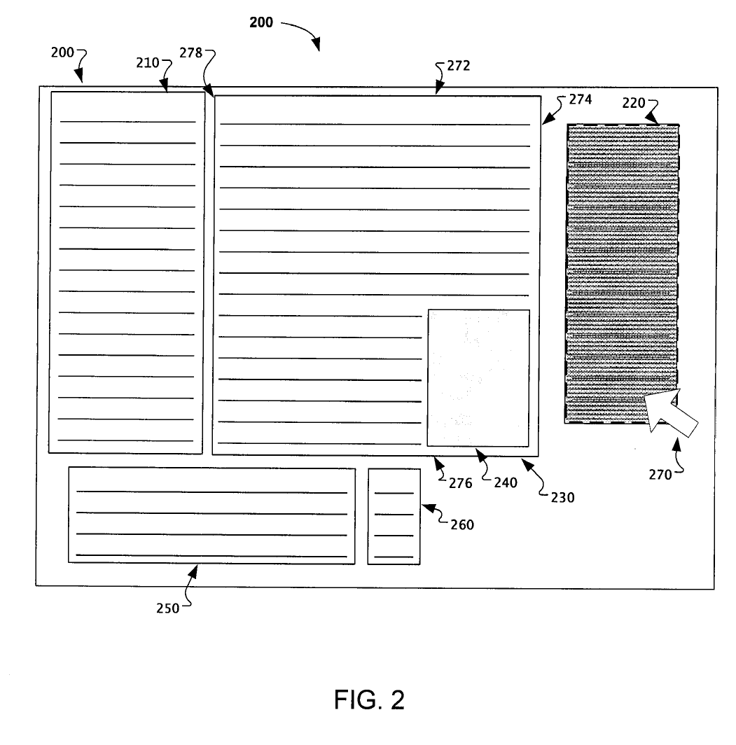

FIG. 2 shows a web page 200 (i.e., one form of a content source) having multiple exemplary structural elements. As shown, the web page 200 includes multiple structural elements 210-260. The structural elements 210-260 can be, for example, a column of text, a paragraph, a table, a part of a table (e.g., cell, row or column), a chart or a graph. The structural elements 210-260 of the web page 200 can include any discrete portion of the web page 200 that has a visual representation when the web page 200 is presented. In some implementations, structural elements 210-260 can include atomic elements that collectively form the web page 200, such as words and characters. In other implementations, structural elements 210-260 can include nested structural elements. For example, the structural element 230 can be a text block that includes an image 240.

In some implementations, if one or more structural elements are identified, the structural element detection module 112 can further evaluate the identified structural element to determine its boundary. The boundary can then be used to determine the spatial dimension (e.g., position, height and width) of the element's visual representation with respect to boundaries of other structural elements. In general, a boundary can be described as a border, margin or perimeter having, for example, horizontal and vertical edges (e.g., a bounding box). For example, structural element 230 includes a surrounding boundary with a top horizontal edge 272, a right vertical edge 274, a bottom horizontal edge 276, and a left vertical edge 278.

### Element Selection Module

Element selection module 116 can be used to facilitate the selection of a structural element whose content (or a portion of the content) is to be clipped. In some implementations, the element selection module 116 includes a cursor detector 118 to track the movement of a cursor 270. The cursor 270 can be a common pointer as controlled by a standard mouse, trackball, keyboard pointer, touch screen or other user manageable devices or navigation tools. A user may navigate around the web page 200 using the cursor 270 and/or a combination of keystrokes. When the cursor 270 is hovered upon an element identified as a structural element by the structural element detection module 112, the element selection module 116 can display a highlighting effect to reflect that a selection of this structural element is available.

### Resize Module

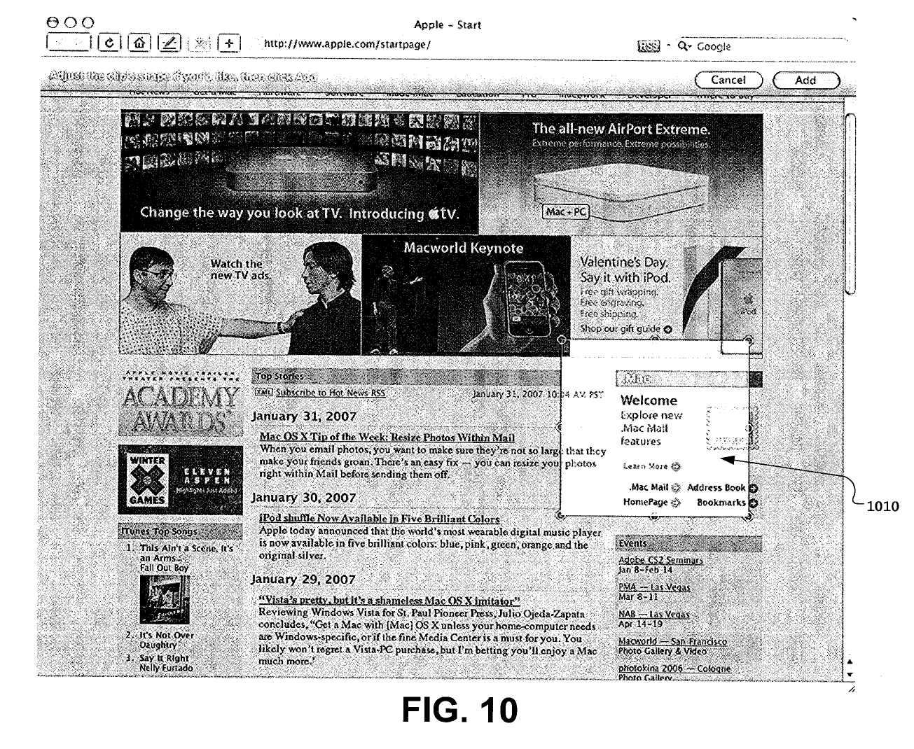

Resizing module 114 is operable to receive user input to resize an area of interest associated with, for example, a web clipping. The resizing module 114 can include a detection mechanism to detect user input (e.g., selection of a corner, a boundary or an edge of a web clipping), for enabling re-sizing. In some implementations, the resizing module 114 is responsive to receipt of user input selecting an edge, a point, or a frame of a structural element and triggers a resizing of the structural element including expanding or reducing the structural element to a particular size or area of interest. Resizing will be described in greater detail below with reference to FIG. 10.

### Render Engine

Render engine 120 may be used to render content that is to be presented to a user in a clipping or during a clip setup process. Render engine 120 may be placed in whole or in part of the content identification engine 110. Alternatively, the render engine 120 may be part of another engine, such as, for example, presentation engine 160 which is discussed below, and a separate stand-alone application that renders content.

Implementations may render one or more entire content sources or only a portion of one or more of the content sources, such as, for example, the area of interest. The area of interest can represent a contiguous area of a content source, such as a frame or the like, or can be an accumulation of two or more non-contiguous or unrelated pieces of content from a single or multiple sources. In particular implementations, an entire web page (e.g., one form of a content source) is rendered, and only the area of interest is actually presented. Rendering the whole web page allows the content identification engine 110 to locate structural markers such as a frame that includes part of the area of interest or an (x,y) location coordinate with reference to a known origin (e.g., creating reference data). Such structural markers, in a web page or other content, may be useful, for example, in identifying the area of interest, particularly during a refresh/update after the content source has been updated and the area of interest may have moved. Thus, a selected area of interest may be tracked. The entire rendered page, or other content source, may be stored (e.g., in a transitory or non-transitory memory) and referenced to provide a frame of reference in determining the selected area of interest during a refresh, for example. In one implementation, the entire rendered page is stored non-transitorily (e.g. on a hard disk) to provide a frame of reference for the initial presentation and for all refresh operations, and content that is accessed and presented in a refresh is not stored non-transitorily. In various implementations, render engine 218 renders content that has been identified using focus engine 214. Identification engine 210 typically is capable of processing a variety of different content formats, navigating within those formats, and rendering those formats. Examples include hypertext markup language (“HTML”); formats of common word processing, spreadsheet, database, presentation, and other business applications; and common image and video formats.

### State Engine

State engine 130 may be used to store information (e.g., metadata) needed to refresh clipped content and implement a refresh strategy. Such information is referred to as state information and may include, for example, a selection definition including an identifier of the content source as well as additional navigation information that may be needed to access the content source, and one or more identifiers associated with the selected area of interest within the content source(s). The additional navigation information may include, for example, login information and passwords (e.g., to allow for authentication of a user or subscription verification), permissions (e.g., permissions required of users to access or view content that is to be included in a given clipping), and may include a script for sequencing such information. State engine 130 also may be used to set refresh timers based on refresh rate preferences, to query a user for refresh preferences, to process refresh updates pushed or required by the source sites or otherwise control refresh operations as discussed below (e.g., for live or automatic updates).

In some implementations, the state engine 130 may store location information that is, for example, physical or logical. Physical location information can include, for example, an (x, y) offset of an area of interest within a content source, including timing information (e.g., number of frames from a source). Logical location information can include, for example, a URL of a web page, HTML tags in a web page that may identify a table or other information, or a cell number in a spreadsheet. State information may include information identifying the type of content being clipped, and the format of the content being clipped.

### Preferences Engine

Preferences engine 140 may be used to query a user for preferences during the process of creating a clipping. Preferences engine 140 also may be used to set preferences to default values, to modify preferences that have already been set, and to present the preference selections to a user. Preferences may relate to, for example, a refresh rate, an option of muting sound from the clipping, a volume setting for a clipping, a setting indicating whether a clipping will be interactive, a naming preference to allow for the renaming of a current clipping, a redefinition setting that allows the user to adjust (e.g., change) the area of interest (e.g., reinitialize the focus engine to select a new area of interest to be presented in a clip view), and function (e.g. filter) settings. Preferences also may provide other options, such as, for example, listing a history of previous content sources that have been clipped, a history of changes to a current clipping (e.g., the changes that have been made over time to a specific clipping thus allowing a user to select one for the current clipping) and view preferences. View preferences define characteristics (e.g., the size, shape, controls, control placement, etc. of the viewer used to display the content) for the display of the portions of content (e.g., by the presentation engine). Some or all of the preferences can include default settings or be configurable by a user.

### Interactivity Engine

Interactivity engine 150 may process interactions between a user and clipped content by, for example, storing information describing the various types of interactive content being presented in a clipping. Interactivity engine 150 may use such stored information to determine what action is desired in response to a user's interaction with clipped content, and to perform the desired action. For example, interactivity engine 150 may (1) receive an indication that a user has clicked on a hyperlink displayed in clipped content, (2) determine that a new web page should be accessed, and (3) initiate and facilitate a request and display of a new requested page. As another example, interactivity engine 150 may (1) receive an indication that a user has entered data in a clipped form, (2) determine that the data should be displayed in the clipped form and submitted to a central database, (3) determine further that the next page of the form should be presented to the user in the clipping, and (4) initiate and facilitate the desired display, submission, and presentation. As another example, interactivity engine 150 may (1) receive an indication that a user has indicated a desire to interact with a presented document, and (2) launch an associated application or portion of an application to allow for a full or partial interaction with the document. Other interactions are possible.

### Presentation Engine

Presentation engine 160 may present clipped content to a user by, for example, creating and displaying a user interface on a computer monitor, using render engine 120 to render the clipped content, and presenting the rendered content in a user interface. Presentation engine 160 may include an interface to a variety of different presentation devices for presenting corresponding clipped content. For example, (1) clipped web pages, documents, and images may be presented using a display (e.g., a computer monitor or other display device), (2) clipped sound recordings may be presented using a speaker, and a computer monitor may also provide a user interface to the sound recording, and (3) clipped video or web pages having both visual information and sound may be presented using both a display and a speaker. Presentation engine 160 may include other components, such as, for example, an animation engine (not shown) for use in creating and displaying a user interface with various visual effects such as three-dimensional rotation.

### Clipview

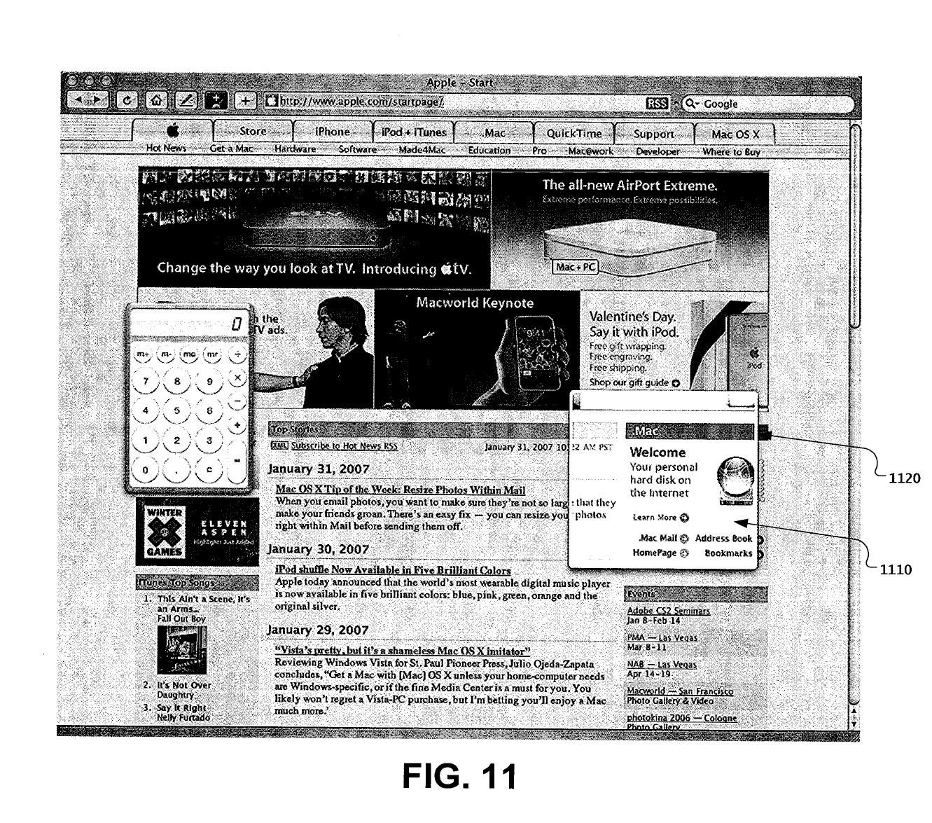

In various implementations, the user interface that the presentation engine 160 creates and displays is referred to as a clipview. In some implementations, the clipview includes a first portion including the clipped content and a second portion for presenting the clipped content. In some implementations, no second portion is defined (e.g., a borderless presentation of the clipview content). In an implementation discussed below, the first portion is referred to as a view portion 1110 (see FIG. 11) in which clipped content is displayed, and the second portion is referred to as a border or frame 1120 which might also include controls. Implementations need not include a perceivable frame or controls, but may, for example, present a borderless display of clipped content, and any controls may be, for example, keyboard-based controls or mouse-based controls without a displayable tool or activation element, overlay controls, on screen controls or the like. The presentation typically includes a display of the clipped content although other implementations may present audio content without displaying any content. The clipview also may include one or more additional portions for presenting information such as, for example, preferences settings and an identifier of the content source. The display of the clip view may be in the user interface of a device, part of a layer presented in the user interface (e.g., as part of an overlay or an on-screen display).

### Clipping Process

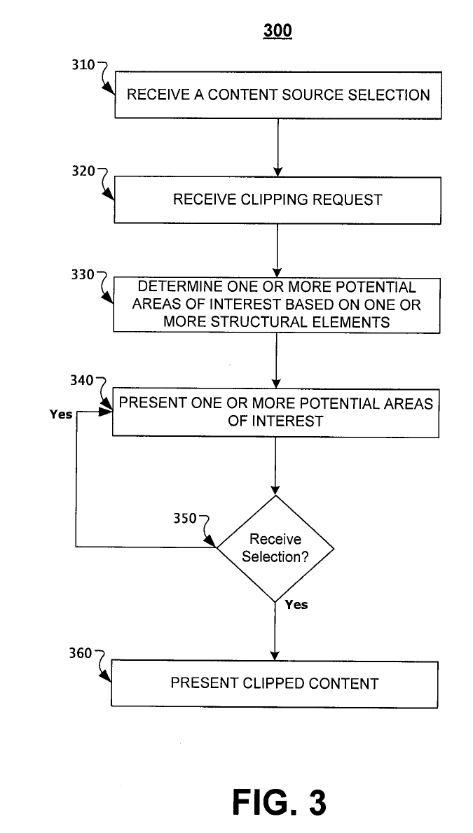

Referring to FIG. 3, a process 300 may be used to create a clipping. Process 300 may be performed, at least in part, by, for example, clipping application 100 running on a computer system.

Process 300 includes receiving a content source(s) selection (310) and receiving a request to clip content (320). Steps 310 and 320 may be performed in the order listed, in parallel (e.g., by the same or a different process, substantially or otherwise non-serially), or in reverse order. The order in which the operations are performed may depend, at least in part, on what entity performs the method. For example, a computer system may receive a user's selection of a content source (step 310), and the computer system may then receive the user's request to launch clipping application 100 to make a clipping of the content source (step 320). As another example, after a user selects a content source and then launches clipping application 100, clipping application 100 may simultaneously receive the user's selection of a content source (step 310) and the user's request for a clipping of that content source (step 320). As yet another example, a user may launch clipping application 100 and then select a content source(s) from within clipping application 100, in which case clipping application 100 first receives the user's request for a clipping (for example, a clipview) (step 320), and clipping application 100 then receives the user's selection of the content source(s) to be clipped (step 310). In other implementations, steps 310 and 320 may be performed by different entities rather than by the same entity.

Process 300 includes determining one or more potential areas of interest (in the selected content source(s)) based on one or more structural elements (step 330). In typical implementations, step 330 requires that the content source(s) be rendered and presented to the user. Based on the content source, one or more potential areas of interest can be determined on behalf of a user. The one or more potential areas of interest determined in step 330 may then be presented (step 340). FIG. 4 is a flow diagram of a process 400 for determining one or more potential areas of interest in a content source.

Temporarily referring to FIG. 4, determining the one or more potential areas of interest may include identifying one or more structural elements (step 410). For example, the structural element detection module 112 can identify each structural element in a content source including spatial extents thereof. For example, the structural element detection module 112 may initially identify one or more elements that may indicate a structural arrangement including text, a paragraph, a table, a portion of a table (e.g., cell, row or column), a chart or a graph. The structural element detection module 112 can then subsequently identify the spatial location of each structural element with respect to their visual presentation in the content source to determine their respective position relative to other structural elements.

In some implementations, all structural elements that have a physical layout in the selected content source can be identified (e.g., by the structural element detection module 112). For example, in a web page, encoded in the Hypertext Markup Language (HTML) or eXtensible HTML (XHTML), all structural elements including document sections (e.g., delineated by the <DIV> tag), images, tables and table elements (e.g., individual rows, columns or cells within a table) can be detected and identified. In these implementations, the structural element detection module 112 can retrieve and analyze the source code(s) associated with a web page (e.g., web page 200) to determine the usage of syntax elements (e.g., tags, attributes, anchors, links, frames, blocks and the like) that may indicate the existence of structural elements.

In some implementations, inline elements, which are typically elements that affect the presentation of a portion of text but do not denote a particular spatial dimension, can be ignored or omitted (i.e., not identified) during detection. In these implementations, any element that is not visible in the presentation of the web page also can be omitted from being identified.

Alternatively, inline elements can be used in identifying structural elements. For example, when an inline element implies a structure (e.g., an image delineated by an <img> tag) or when a particular inline element is identified as having a corresponding structure, such implicit or explicit structural designation can be used in categorizing the element as a structural element. For example, if the inline element is an anchor <a> tag used in a cascading style sheet (CSS) to style the element as a block, then the block is identified as a structural element by the structural element detection module 112. Other (e.g., HTML or XHTML) tag elements or criteria for use in identifying the structural elements also are contemplated.

The process 400 further includes identifying the boundary of each identified structural element (step 420) (e.g., by the structural element detection module 112). All of the identified structural elements have a spatial location that can be described by a boundary having, for example, horizontal and vertical edges (e.g., a bounding box). Optionally, process 400 can include identifying the boundaries of all elements (structural or non-structural) in the content source.

In some implementations, elements that are identified as structural but do not meet a predetermined boundary size are omitted. The boundary size may be based on, for example, coordinates, perimeter or area in which the elements are occupied. For example, elements whose boundary describes a size less than 10% the size of an area of interest are omitted. Similarly, elements whose boundary describes a size larger than 10% the size of an area of interest are omitted. By omitting structural elements that do not meet a predetermined size threshold, the clipping application 100 provide a more accurate search of relevant areas of interest without being distracted by irrelevant materials displayed in the content source.

In some implementations, once a potential area of interest is identified, the structural element corresponding to the potential area of interest is supplemented with one or more visual cues or effects so as to distinctively indicate to the user that the structural element includes potential content of interest (step 430). The visual effect may apply over the associated boundary (e.g., based on coordinates) or bounding box of the structural element to enable the structural element to be discernible from other content in the content source. In some implementations, the visual effect is triggered upon detection of a cursor on the structural element.

In one example, the visual effect may include highlighting the structural element. Highlighting the structural element allows the user to locate an area of interest in the content source quickly and conveniently. For example, when a cursor passes over an element identified as structural, the element displays itself differently in such a way as to draw the attention of the user. As another example, moving the cursor 640 (FIG. 6) from structural element 632 to structural element 635 would initially cause the structural element 632 to be highlighted. As the cursor 640 leaves the region occupied by the structural element 632 and reaches the structural element 635, the structural element 635 is highlighted and the structural element 632 converts back into its original appearance (i.e., no longer is highlighted). In sum, moving the cursor 640 causes a highlight of each structural element disposed in the traveling path of the cursor. Other visual or lighting effects, such as shadows and textures, also are contemplated. It should be noted that the described method of highlighting is not limited to only content or web clipping, and also can be applied to various applications, such as, but not limited to, selecting one or more areas of a page to print, selecting areas of a page to copy, selecting areas of edible HTML content to delete. In these implementations, one or more structural elements can be highlighted based on one or more predetermined criteria. The one or more predetermined criteria may include, but are not limited to, the determination of a reference point in a web page, where the reference point can be, for example, the (x,y) coordinates of the cursor. The coordinates of the cursor can be monitored and collected in real time. Alternatively, the coordinates of the cursor can be collected when the cursor has been stationary for a predetermined time period or upon detection of a cursor status change in movement.

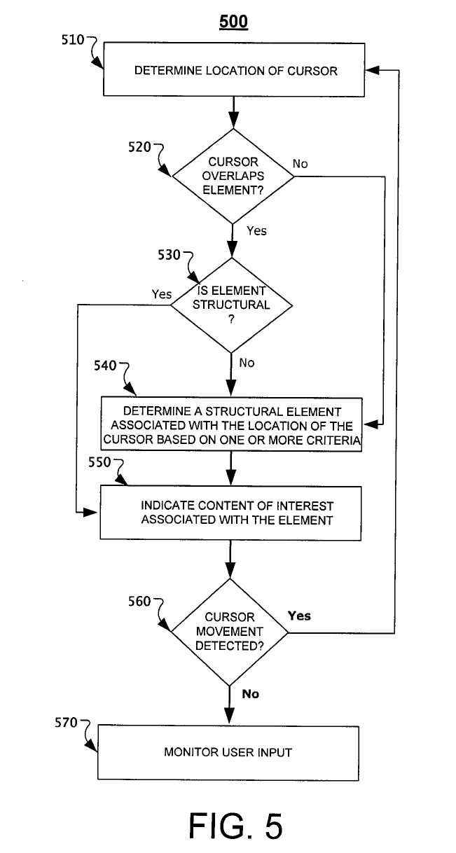

FIG. 5 is a flow diagram of a process 500 for effectuating a visual effect on a structural element. Specifically, when an indication tool (e.g., for the purposes of these discussions a cursor) is placed on a target or element that is identified as structural (e.g., step 420), the user is automatically provided with visual information associated with the structural element to notify the user that the element contains potential content of interest. The visual information may remain active to the user as long as the cursor remains on the structural element.

Referring to FIG. 5, process 500 includes determining the location of a cursor (step 510). The movement of cursor can be controlled generally in response to input received from the user using an input device including, for example, a keyboard or keyboard pointer (e.g., a keyboard shortcut), a mouse, a trackball, touch screen or other user manageable devices or navigation tools. Determining the location of the cursor may include determining the (x,y) coordinates or relative position of the cursor with respect to other elements (e.g., structural or non-structural) in the content source. Step 510 can be executed instantaneously in particular implementations upon receiving a clipping request (e.g., step 320).

Once the (x,y) coordinates or relative position of the cursor is known, process 500 can proceed with determining whether the cursor hovers on or overlaps an element (step 520). Particularly, process 500 can determine whether the cursor is positioned on an empty space, a tool bar, menu bar, status bar, or other navigation tool that is part of the browser displaying the content but is not part of the content source. In some implementations, determining whether the cursor overlaps an element may include comparing the coordinates or relative position of the cursor against the coordinates or boundaries of each (structural or non-structural) element (e.g., retrieved in step 420). For example, if the cursor is located at (0,0) and an element occupies a rectangular region defined by (1,1), (1, −1), (−1, 1) and (−1, −1), then the cursor is positioned on the element. If it is determined that the cursor overlaps an element (“Yes” branch of step 520), the element is evaluated to determine if the element is structural (step 530). For example, the element can be compared to those elements already identified as structural elements in step 410. Steps 520 and 530 can be conflated in particular implementations in which all elements have previously been identified as structural. If the element is one of the elements identified as structural (“No” branch of step 530) (e.g., if the element is not among the elements identified as structural elements in step 410), then a default structural element associated with the location of the cursor is determined based on one or more criteria (step 540). In some implementations, the one or more criteria may include distance among the structural elements relative to the location of the cursor. For example, if the cursor is closer, in distance, to an article on a new commercial product than a weekly editorial on government policy, then the article on the new commercial product is selected as the default structural element that may contain potential content of interest. In another implementations, the one or more criteria may include a boundary that meets a specific size. Size specification can occur automatically (e.g., by clipping application 100), or by user prompt. In one example, the size of the boundary for each structural element is compared to the specified size to locate one element that meets or substantially meets the specified size. If one or more elements are identified as meeting this size threshold, then the element closest to the location of the cursor is selected. This operation (i.e., step 540) is also executed if it is determined that the cursor is not positioned on an element (“No” branch of step 520).

Concurrently or sequentially, the identified element, which contains potential content of interest, can be indicated to the user (step 550). The identified element can be supplemented with one or more visual cues or effects so as to distinctively indicate to the user that the structural element includes potential content of interest (e.g., step 430). The operation performed in step 550 is also executed if it is determined that the element on which the cursor overlaps is structural (“Yes” branch of step 530).

In some implementations, the user can indicate whether the suggested areas of interest are desirable. All of the potential areas of interested can be presented individually or separately. In these implementations, the mechanics of how each potential area of interest is indicated to the user can be accomplished in a variety of ways. In one example, user input is monitored (step 570). Particularly, each potential area of interest is indicated to the user via a “mouseover” effect. As the user navigates around the web page using a cursor (e.g., a mouse or other input pointer devices), the position of the cursor is monitored. When the cursor rests upon an element identified as a structural element whose content includes an area of interest, a change in the element's visual appearance is triggered (e.g., to another color, contrast or brightness). The user can select the potential area of interest by locking down (e.g. clicking on) the structural element. In another example, an indicator or special symbol (e.g., “Add” symbol) can be implemented next to each potential area of interest. Should the user desire to select a particular one of the presented areas of interest, the user can simply click on a corresponding indicator to initiate clipping of the associated content. In yet another example, structural elements pertaining to advertisements may be automatically detected (e.g., by the content identification engine 110), and removed from structural selection (e.g., by the element selection module 116). In yet another example, the clipping application 100 automatically determines a best area of interest suitable for the user based on one or more predetermined criteria regardless of the position of the cursor. The one or more predetermined criteria may be content-driven data that include a user's past behavior with respect to online transactions or functions performed, type of web site the user has visited, or marketing desires. Other criteria such as user-specified preferences or preferences determined based on user behaviors (e.g., preferences of images over text, or preferences with animated content over static images) also are contemplated. In these examples, the user may manually override the proposed area(s) of interest, and select a different area of interest.

In other implementations, instead of using a cursor to trigger the display of the potential areas of interest, a presentation to the user can be made that includes displaying all of the potential areas of interested at once. In this example, each of the potential area of interest may include additional graphic effect (e.g., exposure, lightening, texture, etc.) to visually differentiate over other irrelevant content in the content source.

Process 500 also includes detecting cursor movement (step 560). When movement of the cursor is detected (e.g., as the cursor moves across a web page) (“Yes” branch of step 560), the location of the cursor is reevaluated again (step 510). For example, a comparison can be made between the new coordinates of the cursor and those of the structural elements to determine if the cursor at the new location overlaps an element. If no cursor movement is detected (“No” branch of step 560), user input continues to be monitored (step 570). For example, user selection of any of suggested potential areas of interest may be monitored.

Referring back to FIG. 3, if user selection of a potential area of interest is received (“Yes” branch of step 350), associated content can be presented to a user by, for example, creating and displaying a user interface on a computer monitor, rendering the selected content, and presenting the rendered content in a user interface (e.g., by the presentation engine 160) (step 360). For example, clipped web pages, documents, and images may be presented using a widget, as will be described in greater detail below in the “Web Instantiation” section. If no user selection is received, one or more potential areas of interest can be continued to be indicated to the user (“No” branch of step 350).

In some implementations, prior to presenting the clipped content in the user interface, a bounding box can be drawn over the area of interest associated with the selected structural element allowing the user to manipulate and adjust the size of the area of interest. In some implementations, the area of interest can be resized by selection and movement of one or more of the area's edges. For example, selecting and moving the edge of the area of interest can render the area larger or smaller. Alternatively, the area of interest can be repositioned or panned relative to the content of the document, without changing the size of the area. Content within the bounding box is subsequently clipped based on the newly defined area of interest.

In some implementations, the clipped content is a static content. In other implementations, the clipped content is a refreshable content. A static clipping reflects a selected area of interest with respect to the selected content source at the time the clipping was defined, irrespective of update or modification. For example, if a static clipping displays a weather forecast for Feb. 6, 2007, then the static clipping will show the weather forecast for Feb. 6, 2007, even if the content at the content source associated with the clipping is updated to reflect a new weather forecast (e.g., weather forecast for Feb. 7, 2007). In contrast, a refreshable clipping depicts new or updated content specified from the selected content source and within the selected area of interested associated with the clipping. For example, if ‘http://www.cnn.com’ had been updated with an alternative headline, then the clipping would depict the updated headline.

A refreshable clipping ideally depicts the content currently available from the source. In some implementations, a refreshable clipping can initially depict the content last received from the source (e.g., when the clipping was previously presented), while the source is accessed and the content is being refreshed. An indication can be made that the clipping is being, or has been, refreshed (e.g., an icon, progress bar, etc.). The indication can be displayed with the clipping (e.g., as an overlay), in a status bar, toolbar, etc. Alternatively, if it is not possible to access the content from the source (e.g., the source is not accessible, etc.), another indication can be displayed. Such an indication might include a message in a status bar, a dialog, log or any other suitable feedback.

In another implementations, the user can select whether the clipping is a refreshable clipping or a static clipping by choosing a refresh strategy. Refresh strategies can include making the clipping refreshable or static. Other refresh strategies are possible. For example, clippings can be refreshed when the clipping is presented, but only if the content has not been refreshed within a particular time period. In some implementations, a refresh strategy can specify that refreshable clippings will be refreshed at a particular interval of time, whether or not the clipping is currently being presented. Alternatively, a clipping can be refreshed by receiving user input (e.g., refresh on demand). Further description regarding the refresh properties and techniques thereof can be found in a related U.S. patent application Ser. No. 11/145,561 titled “Presenting Clips of Content”, U.S. patent application Ser. No. 11/145,560 titled “Webview Applications”, each disclosure of which is incorporated herein by reference in its entirety.

A system, processes, applications, engines, methods and the like have been described above for clipping content associated with an area of interest from one or more content sources and presenting the clippings in an output device (e.g., a display). Clippings as described above can be derived from one or more content sources, including those provided from the web (i.e., producing a webview), a datastore (e.g., producing a docview) or other information sources.

Clippings as well can be used in conjunction with one or more applications. The clipping system can be a stand alone application, work with or be embedded in one or more individual applications, or be part of or accessed by an operating system. The clipping system can be a tool called by an application, a user, automatically or otherwise to create, modify and present clippings.

The clipping system described herein can be used to present clipped content in a plurality of display environments. Examples of display environments include a desktop environment, a dashboard environment, an on screen display environment or other display environment.

Described below are example instantiations of content, applications, and environments in which clippings can be created, presented or otherwise processed. Particular examples include a web instantiation in which web content can be displayed in a dashboard environment (described in association with FIGS. 6-12). Other examples include “widget” (defined below) instantiation in a desktop display environment. Other instantiations are possible.

### Web Instantiation

A dashboard, or sometimes referred to as a “unified interest layer”, includes a number of user interface elements. The dashboard can be associated with a layer to be rendered and presented on a display. The layer can be overlaid (e.g., creating an overlay that is opaque or transparent) on another layer of the presentation provided by the presentation device (e.g. an overlay over the conventional desktop of the user interface). User interface elements can be rendered in the separate layer, and then the separate layer can be drawn on top of one or more other layers in the presentation device, so as to partially or completely obscure the other layers (e.g., the desktop). Alternatively, the dashboard can be part of or combined in a single presentation layer associated with a given presentation device.

One example of a user interface element is a widget. A widget generally includes software accessories for performing useful, commonly used functions. In general, widgets are user interfaces providing access to any of a large variety of items, such as, for example, applications, resources, commands, tools, folders, documents, and utilities. Examples of widgets include, without limitation, a calendar, a calculator, and address book, a package tracker, a weather module, a clipview (i.e., presentation of clipped content in a view) or the like. In some implementations, a widget may interact with remote sources of information (such as a webview discussed below), such sources (e.g., servers, where a widget acts as a client in a client-server computing environment) to provide information for manipulation or display. Users can interact with or configure widgets as desired. Widgets are discussed in greater detail in concurrently filed U.S. patent application entitled “Widget Authoring and Editing Environment.” Widgets, accordingly, are a container that can be used to present clippings, and as such, clipping application 100 can be configured to provide as an output a widget that includes clipped content and all its attending structures. In one implementation, clipping application 100 can include authoring tools for creating widgets, where such widgets are able to present clipped content.

In one particular implementation described in association with FIGS. 6-12, a clipping application allows a user to produce a clipping of web content. The clipping application receives an area of interest from the (one or more) web page(s) (e.g., by the selection of a structural element) containing the content to be clipped, and allows a user to size (or resize) the area of interest. The clip is then subsequently displayed in a window of a widget created by the clipping application, and both the widget and the clipping application are separate from the user's browser. The content from the area of interest, including hyperlinks, radio buttons, and other interactive portions, is displayed in a window referred to as a webview, and is refreshed automatically, or otherwise by the clipping application or other refresh sources to provide the user with the latest or updated (or appropriate) content from the area of interest.

The clipping application 100 can store identifying information for the webview as a non-transitory file that the user can select and open. By storing the identifying information as a file, the clipping application enables the user to close the webview and later to reopen the webview without having to repeat the procedure for selecting content and for sizing and positioning the webview. The identifying information includes, for example, a uniform resource locator (“URL”) of the one or more web pages, as well as additional information (e.g., a signature) that might be required to locate and access the content in the selected area of interest. The identifying information also may include the latest (or some other version, such as the original clipping) content retrieved from the area of interest. Thus, when the user reopens a webview, the clipping application may use the identifying information to display the latest contents as well as to refresh those contents.

### Identifying Clipped Content

FIG. 6 is a screen shot of an exemplary implementation of a web browser 600. As shown, the web browser 600 is a Safari® application window 650. The window 650 contains a content display area 610 and a toolbar 620. The toolbar 620 can receive user input which, in general, affects the content displayed in the display area 610. A user can provide input using an input device, including a keyboard or keyboard pointer (e.g., a keyboard shortcut), a mouse, a trackball, a track-pad or a table (e.g., clicking on a button, performing an predetermined gesture, etc.), touch screen or other user manageable devices or navigation tools. The input device can generally control movement of the cursor 640 in response to input received from the user.

The toolbar 620 includes user interface elements such as an address field 622 (e.g., for defining a URL), a refresh button 623 (e.g., for refreshing the display area 610), a home page button 624, an auto-fill button 625 (e.g., for automatically entering data without user intervention), a web-clip button 626 and a bookmark button 627. Receiving user input directed to one of the user interface elements in the toolbar 620 can affect how the content is displayed in the content display area 610. For example, a user can provide input to the address field 622 that specifies a particular content source. The source can be provided as a Universal Resource Locator (URL). In the example shown, the address bar 622 contains ‘http://www.apple.com/startpage/’ specifying that the user is interested in the content provided by Apple®. In response, content from ‘http://www.apple.com/startpage/’ is loaded into the display area 610 (e.g., by the content identification engine 110, the presentation engine 120 or in combination with one or more other engines as described in reference to FIG. 1). This is one of a number of possible starting points for creating clipped content as discussed above. Once a particular web page has been identified, the clipping application can be initiated. Initiation can occur automatically, or by user prompt. Other means of initiating the clipping application are possible, including by an authoring application, by user interaction, by a call or the like as described above.

Content can be received from the location specified in the address bar 622, and encoded with information that describes the content and specifies how the content should be displayed. For example, content can be encoded using HTML, eXtensible Markup Language (XML), graphic image files (e.g., Graphic Interchange Format (GIF), Joint Photographic Expert Group (JPEG), etc.), or any other suitable encoding scheme. In general, a web browser, such as web browser 600, is capable of rendering the variety of content including files, images, sounds, web pages, RSS feeds, chat logs, email messages, video, three-dimensional models and the like.

The browser 600 can receive a clipping request from input provided by a user. For example, the user can click on the web clip button 626 located in the toolbar 620 to activate a clip creation process. The clipping request can be followed by spatially defining an area of interest (e.g., a section of text, a portion of a rendered display, a length of sound, an excerpt of video, etc.) within the content source that defines a particular portion(s) of content to be clipped. The content source can include any content source of content that can be captured and presented (e.g., a file containing images, text, graphics, music, sounds, videos, three-dimensional models, structured information, or input provided by external devices (e.g., digital camera, video camera, web cam, scanner, microphone, etc.)).

As mentioned earlier, content identification engine 110 may assist a user in providing a number of potential areas of interest, and selecting an area of interest suitable for clipping. Such assistance may include, for example, proposing certain areas as areas of interest based on general popularity, a user's past behavior, or marketing desires. For example, a web page may identify a popular article and suggest that users visiting the web page make a clipping of the article. As another example, content identification engine 110 may track the frequency with which a user visits certain content, or visits certain areas of interest within the content, and if a particular area of interest is visited frequently by a user, then content identification engine 110 may pre-create a clipping for the user that merely has to be selected and located, in for example, a dashboard. Such areas of interest may include, for example, a web page, a particular portion of a web page such as a weekly editorial, a particular frame of a web page, a folder in an email application (such as, for example, an inbox), and a command in an application that ordinarily requires navigating multiple pull-down menus.

In some implementations, content identification engine 110 may further assist the user in automatically identifying one or more potential areas of interest as the user navigates around the web page 650. For example, the content identification engine 110 can execute a structure recognition mechanism that includes searching and evaluating a particular content source for one or more structural elements (e.g., a column of text, a paragraph, a table, a chart and the like). Multiple content sources also may be searched, and searches may be performed for text codes (for example, American Standard Code for Information Interchange (“ASCII”)), image patterns, video files, advertising banners and other suitable items. As an example, the content in the display area 610 can be parsed and searched (e.g., by structural element detection module 112) to assess one or more elements (e.g., element 631-639) that have a physical layout or structure (e.g., a text block). Each of these elements, referred to as a structural element, generally includes a respective boundary that identifies the spatial extent (e.g., position, height and width, etc.) of the element's visual representation with respect to the rest of the document content. Once the structural elements are identified, corresponding boundaries and coordinates thereof also are collected. For example, referring to FIG. 6B, structural element 636 includes a region bound by a boundary having four coordinates (X_{A}, Y_{A}), (X_{A}, Y_{B}), (X_{B}, Y_{A}) and (X_{B}, Y_{B}). These coordinates and other information associated with the spatial location of the structural elements 631-639 can be stored, for example, in a local memory or buffer. Alternatively, information associated with the coordinates of the structural elements 631-639 can be stored in a date file, and the data file can be updated on a periodic basis to reflect changes of the content in the web page 650 that may have shifted the spatial location of the structural elements 631-639.

The structural elements 631-639, once identified, may be useful, for example, in assisting the user quickly identify one or more potential areas of interest without being distracted by irrelevant materials presented and displayed in a web page or document. In some implementations, the structural elements 631-639 are supplemented with one or more visual cues or effects to indicate to the user that these elements include potential content of interest (e.g., weekly editorial, box scores, daily horoscope, breaking news). The visual effect can be implemented using, for example, a highlighting feature. Highlighting a structural element allows the user to locate a potential area of interest in the content quickly and conveniently.

In some implementations, the visual effect is automatically applied to a structural element upon detection of a cursor on the structural element. For example, when a cursor passes over an element identified as structural, the element displays itself differently in such a way as to draw the attention of the user. As another example, moving the cursor 640 from structural element 632 to structural element 635 would initially cause the structural element 632 to be highlighted. As the cursor 640 leaves the region occupied by the structural element 632 and reaches the structural element 635, the structural element 635 is highlighted and the structural element 632 is converted back into its original appearance (i.e., no longer is highlighted). In sum, moving the cursor 640 causes a highlight of each structural element disposed in the traveling path of the cursor. Other animation, visual or lighting effects, such as shadows and textures, also are contemplated.

In these implementations, one or more structural elements can be highlighted based on one or more predetermined criteria. The one or more predetermined criteria may include, but is not limited to, the determination of a reference point in a web page, where the reference point can be, for example, the (x,y) coordinates of the cursor. The coordinates of the cursor can be monitored and collected in real time. Alternatively, the coordinates of the cursor can be collected when the cursor has been stationary for a predetermined time period or upon detection of a cursor status change in movement.

When movement of the cursor is detected (e.g., as the cursor moves across a web page), a comparison between the coordinates of the cursor and those of the structural elements is executed to discern whether the cursor overlaps any one of the structural elements. If it is determined that the cursor overlaps or is positioned over a structural element, the structural element can be highlighted to visually notify the user that the cursor is located on a structural element that may be a potential area of interest.

For example, referring back to FIG. 6A, the (x,y) coordinates of the cursor's 640 location are monitored in real time (e.g., by the cursor detector 118). Alternatively, the coordinates of the cursor's location are retrieved upon detecting inactivity of the cursor 640. The coordinates of the cursor 640 can be stored in a computer buffer or other memory locations. Concurrently or sequentially, coordinates associated with the structural elements 631-639 and their respective boundaries are retrieved (e.g., from the data file). The coordinates of the cursor 640 can be checked against those of the structural elements 631-639 to determine whether the cursor 640 overlaps a region bounded by the boundaries of any one of the structural elements 631-639. If it is detected that the cursor 640 is hovered on a structural element, the structural element is graphically highlighted.

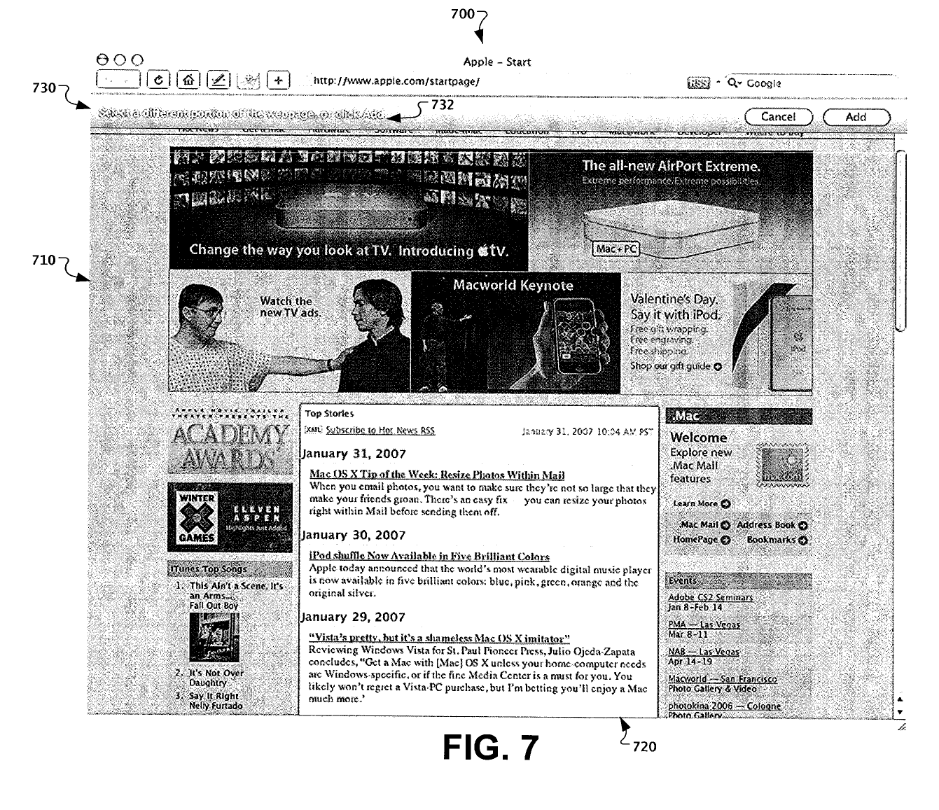

In some implementations, a semi-transparent layer can be used to further enhance such a visual effect. Referring to FIG. 7, an overlay can be displayed in the web page 700 as a semi-transparent layer 710 that alters (e.g., darkens, obfuscates, fades, etc.) the content presented in the display area 610. The semi-transparent layer 710 may be translucent to enable the overlaid items to be discernible or opaque. The content within an area of interest can be highlighted by the absence of the semi-transparent layer 710 within the area of interest. In the example shown, the structural element 720 is presented displaying a highlighting effect to reflect that the structural element 720 is a potential area of interest whose content can be clipped.

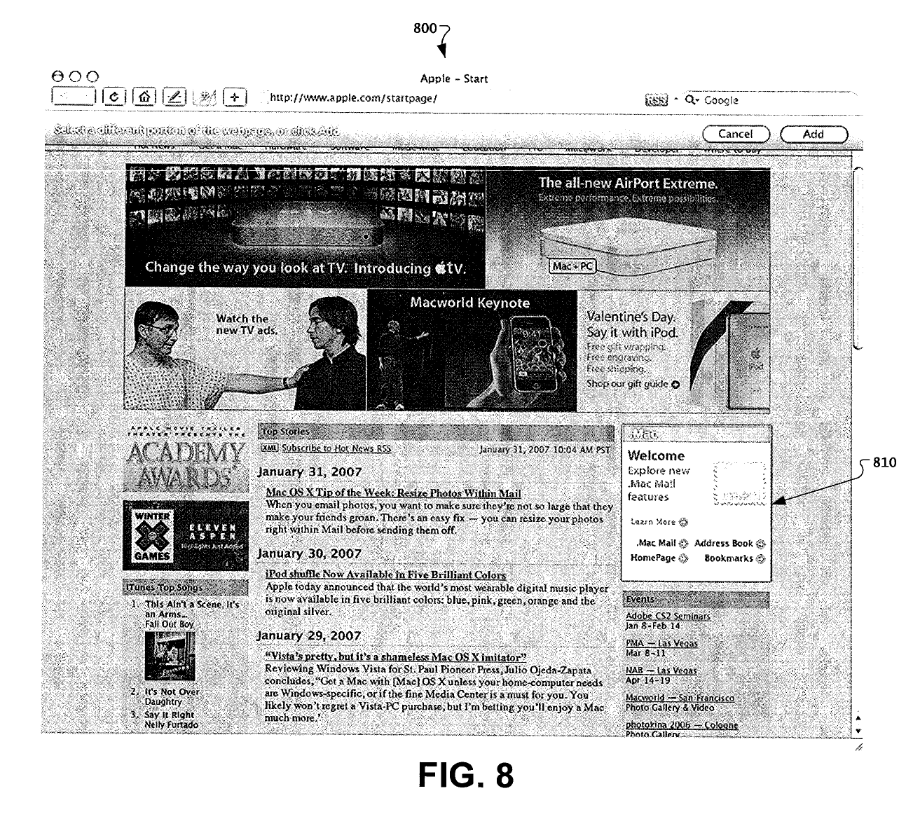

In another implementations, should the user decide that the content in the structural element 720 is not so desired, a new area of interest can be manually defined by the user. A banner 730 can be displayed to provide instructions to the user to navigate to a different area of interest. For example, the user can navigate to a different structural element (e.g., navigate using the cursor 640), such as the text block 810 in the web page 800 shown in FIG. 8. The banner 730 also can contain one or more user interface elements which can assist the user in, for example, confirming a new area of interest (e.g., “Add” selector 732) prior to creating a clipping based on the new area of interest. Once the “Add” selector 732 is clicked, a currently highlighted element is clipped.

In some implementations, the selected area of interest can be defined, resized, repositioned or otherwise manipulated in response to user input (e.g., mouse, keyboard, tablet, touch sensitive screen, etc.). For example, once the user has confirmed a selected area of interest (e.g., text block 810), the user can further modify the area of interest to include additional content or remove undesired materials by locking down the currently highlighted area of interest (e.g., by clicking on the selected element). Locking down a selected area of interest provides the user additional flexibility to specify text, pictures, tables, and other content elements or portion thereof to be included in the selected area of interest.

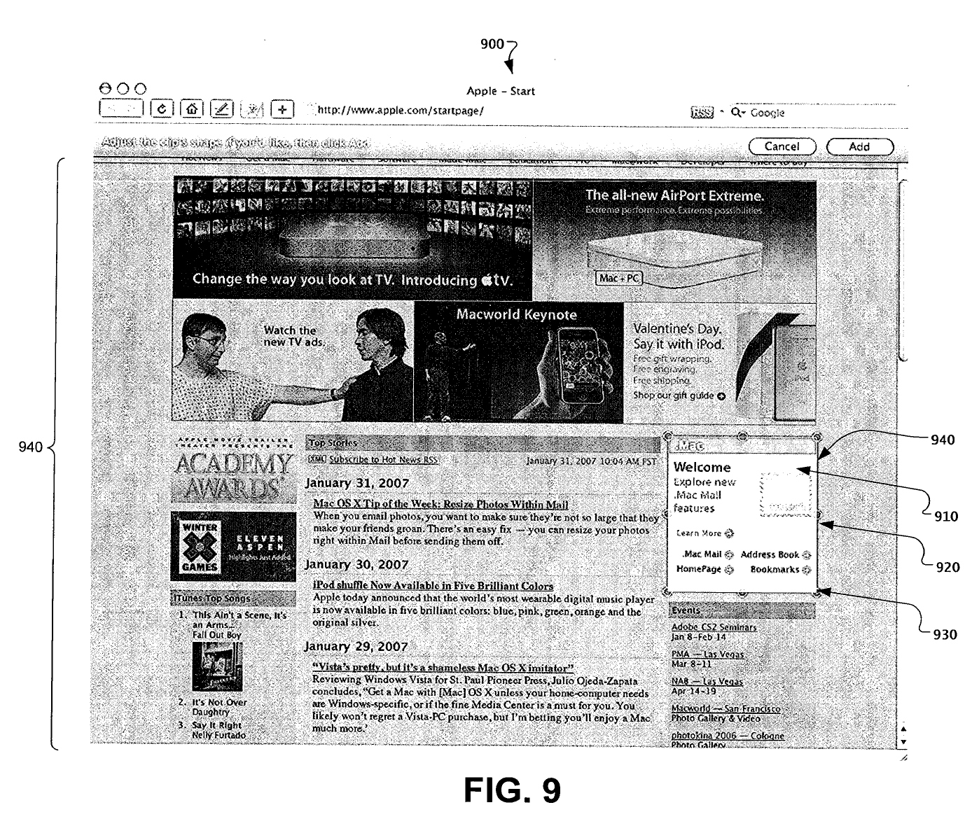

Referring to FIG. 9, once a selected area of interested is locked in place, the area of interest can be manipulated (e.g., sized and positioned) directly with respect to the presentation of the web page 900 (e.g., before the web clip is created), or can be manipulated indirectly (e.g., by manipulating a web clip with which the area of interest is associated). For example, a border 920 and size controls 930 (e.g., handles) can be displayed surrounding the area of interest 910. A user input can be received to manipulate the area of interest 910 by selection and movement of any one of the edges (e.g., top edge, bottom edge, left edge and right edge) of the border 920. The area of interest 910 can also be clicked and dragged anywhere within the display area 940 to include additional content coverage. For example, selecting and moving the right edge 940 of the border 920 renders the area of interest 910 wider or narrower. Alternatively, the area of interest 910 can be repositioned or panned relative to the content of the web page 900, without changing the size of the area of interest. As shown in FIG. 10, the area of interest 1010 is repositioned to include additional areas of interest and remove unwanted content.

A clipping can be associated with information for displaying the content contained within the area of interest 1010. For example, the clipping can be associated with information about the location of content (e.g., the address ‘http://www.apple.com/startpage/’ in the address bar 622) and the location and size of the area of interest (e.g., 1010). In another example, the position and dimension of a bounding box defined by the border 920 can be described as a square 100 units wide and 100 units high, which is to be positioned 500 units down and 600 units right from the top left corner of the display area 610.

The clipping can be associated with information about the configuration of the display area 610 at the time the area of interest 1010 is defined, such as the original size of the display area 610 (e.g., 800 units wide by 600 units long). Associating the clipping with information about the configuration of the display area 610 can be important when the presentation of content is normally dependant on the configuration of the display area 610 (e.g., web pages, unformatted text, etc.). The clipping can also be associated with captured content (e.g., an image of the content shown in the area of interest 1010).

In some implementations, an animation can be rendered to indicate that a clipping based on the selected area of interest has been created. The animation ideally emphasizes to the user the notion that the content within an area of interest has been clipped from the rest of the content. In one implementations, this animation effect can be achieved by rendering the content using a three-dimensional display subsystem (e.g., an implementation of the OpenGL API). In another implementations, clipped content can be added to a dashboard layer, as described in U.S. patent application Ser. No. 10/877,968, for “Unified Interest Layer For User Interface”, the disclosure of which is incorporated herein by reference in its entirety.

Clipped content also can be presented to a user by, for example, creating and displaying a user interface on a computer monitor, using render engine 120 to render the clipped content, and presenting the rendered content in a user interface by the presentation engine 160. For example, clipped web pages, documents, and images may be presented using a display (e.g., a computer monitor or other display device), clipped sound recordings may be presented using a speaker, and clipped video or web pages having both visual information and sound may be presented using both a display and a speaker.

As shown in FIG. 11, the presentation engine 160 allows a user to display a clipping of the web content 1110 corresponding to the content within the area of interest 1010. The clip can be displayed in a window as a widget 1120 created by the presentation engine 160. The presentation engine 160 allows the user to size the widget 1120, referred to as a webview. The content from an area of interest (e.g., 1010), including hyperlinks, radio buttons, and other interactive portions, is displayed in the webview and is refreshed automatically, or otherwise by the clipping application or other refresh source to provide the user with the latest (or appropriate) content from the area of interest.

In this instantiation, the clipping application 100 can store identifying information for the webview as a non-transitory file that the user can select and open. By storing the identifying information as a file, the clipping application enables the user to close the webview and later to reopen the webview without having to repeat the procedure for selecting content and for sizing and positioning the webview. The identifying information includes, for example, a uniform resource locator (“URL”) of the one or more web pages, as well as additional information that might be required to locate and access the content in the selected area of interest. The identifying information also may include the latest (or some other version, such as the original clipping) content retrieved from the area of interest. Thus, when the user reopens a webview, the clipping application may use the identifying information to display the latest contents as well as to refresh those contents.

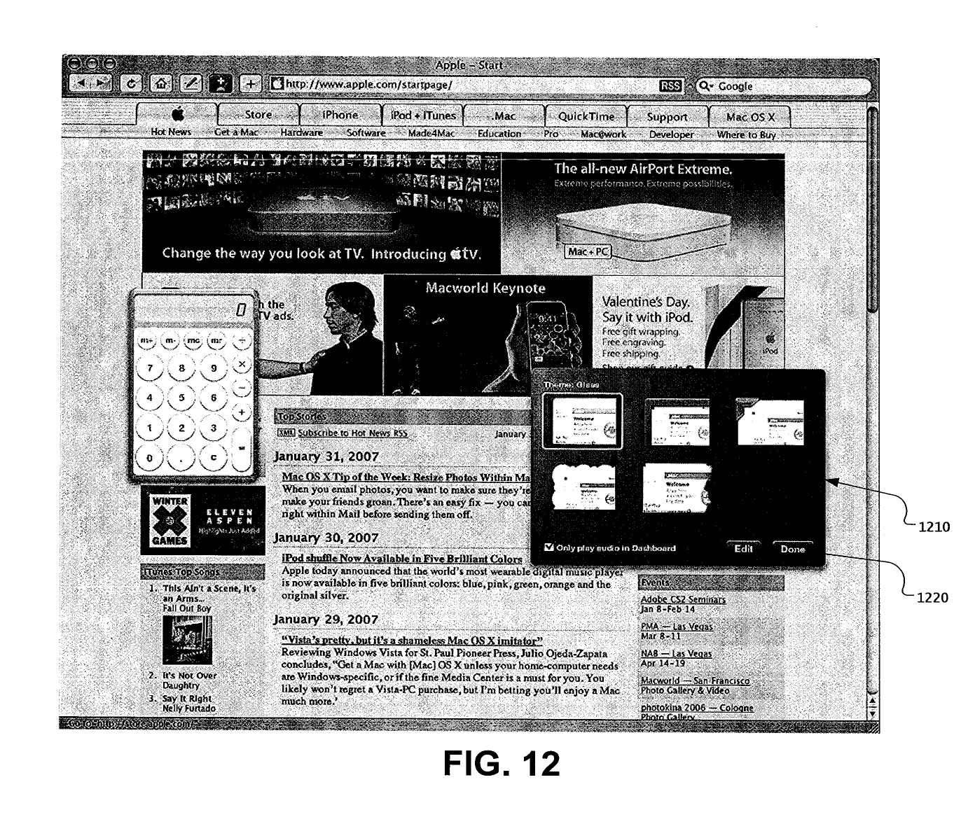

In some implementations, properties affecting the appearance of the widget 1120 can be manually defined by the users. Users can modify the appearance or presentation of the widget 1120 by invoking a preference window. FIG. 12 is a screen shot showing a preference window for choosing a display theme for a widget. Referring to FIG. 12, the preference window 1210 can include a “Edit” button 120 that may be selected by the user to effectuate the effect associated with a selected preference, and a “Done” button 1220 that may be selected by a user when the process of configuring the appearance of the widget 1120 is complete.

In some implementations, the preference window 1210 can include parameters to allow a user to scale, rotate, stretch, and apply other geometrically transformations to the widget 1120. Users can also modify the appearance of the widget 1120 to their preference by adding one or more window themes including, without limitation, psychedelic, stone, parchment, grass, wood grain, pastel, steel or glass to the widget 1120. Other structural additions such as borders and frames also are contemplated.

While the above implementations have been described with respect to clipping content, it should be noted that these implementations also can be applied to various applications, such as, but not limited to, selecting one or more areas of a page to print, selecting areas of a page to copy, or selecting areas of edible HTML content to delete.

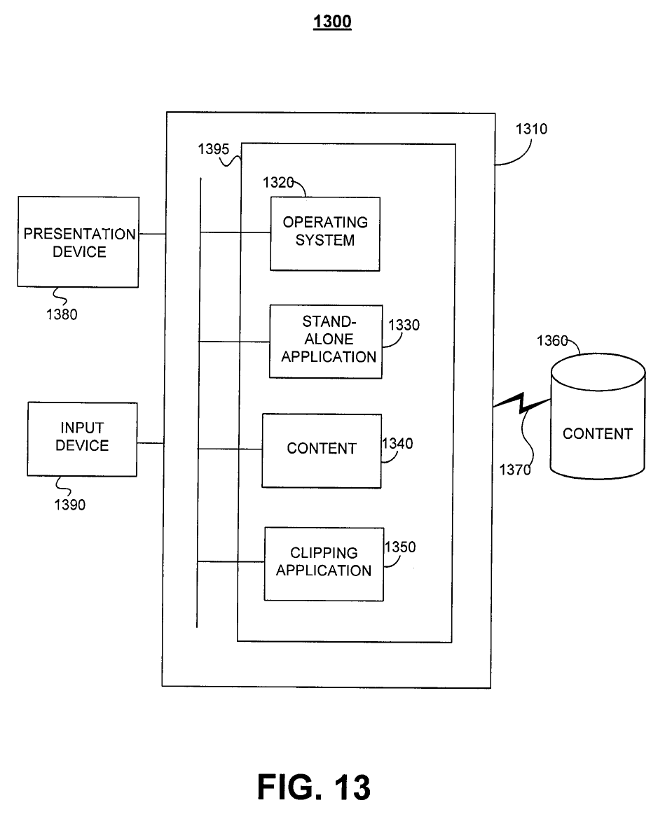

FIG. 13 is a block diagram showing a system for clipping content. Referring to FIG. 13, a system 1300 is shown for clipping content and presenting the clippings (or sometimes referred below as a clipview, webview, or other “X” views) to a user. System 1300 includes a processing device 1310 having an operating system 1320, a stand-alone application 1330, a content source 1340, and a clipping application 1350. Each of elements 1320-1350 is communicatively coupled, either directly or indirectly, to each other. Elements 1320-1350 are stored on a memory structure 1395, such as, for example, a hard drive. System 1300 also includes a presentation device 1380 and an input device 1390, both of which are communicatively coupled to processing device 1310. System 1300 further includes a content source 1360 that may be external to processing device 1310, and communicatively coupled to processing device 1310 over a connection 1370.

Processing device 1310 may include, for example, a computer, a gaming device, a messaging device, a cell phone, a personal/portable digital assistant (“PDA”), or an embedded device. Operating system 1320 may include, for example, MAC OS X from Apple Computer, Inc. of Cupertino, Calif. Stand-alone application 1330 may include, for example, a browser, a word processing application, a database application, an image processing application, a video processing application or other application. Content source 1340 and content source 1360 may each include, for example, a document having any of a variety of formats, files, pages, media, or other content, and content sources 1340 and 1360 may be compatible with stand-alone application 1330. Presentation device 1380 may include, for example, a display, a computer monitor, a television screen, a speaker or other output device. Input device 1390 may include, for example, a keyboard, a mouse, a microphone, a touch-screen, a remote control device, a speech activation device, or a speech recognition device or other input devices. Presentation device 1380 or input device 1390 may require drivers, and the drivers may be, for example, integral to operating system 1320 or stand-alone drivers. Connection 1370 may include, for example, a simple wired connection to a device such as an external hard disk, or a network, such as, for example, the Internet. Clipping application 1350 as described in the preceding sections may be a stand-alone application as shown in system 1300 or may be, for example, integrated in whole or part into operating system 1320 or stand-alone application 1330.

Processing device 1310 may include, for example, a mainframe computer system, a personal computer, a personal digital assistant (“PDA”), a game device, a telephone, or a messaging device. The term “processing device” may also refer to a processor, such as, for example, a microprocessor, an integrated circuit, or a programmable logic device. Content sources 1340 and 1370 may represent, or include, a variety of non-volatile or volatile memory structures, such as, for example, a hard disk, a flash memory, a compact diskette, a random access memory, and a read-only memory.

Implementations may include one or more devices configured to perform one or more processes. A device may include, for example, discrete or integrated hardware, firmware, and software. Implementations also may be embodied in a device, such as, for example, a memory structure as described above, that includes one or more computer readable media having instructions for carrying out one or more processes. The computer readable media may include, for example, magnetic or optically-readable media, and formatted electromagnetic waves encoding or transmitting instructions. Instructions may be, for example, in hardware, firmware, software, or in an electromagnetic wave. A processing device may include a device configured to carry out a process, or a device including computer readable media having instructions for carrying out a process.

A number of implementations have been described. Nevertheless, it will be understood that various modifications may be made. For example, elements of one or more implementations may be combined, deleted, modified, or supplemented to form further implementations. Additionally, in further implementations, an engine 110-160 need not perform all, or any, of the functionality attributed to that engine in the implementations described above, and all or part of the functionality attributed to one engine 110-160 may be performed by another engine, another additional module, or not performed at all. Though one implementation above describes the use of widgets to create webviews, other views can be created with and presented by widgets. Further, a single widget or single application can be used to create, control, and present one or more clippings in accordance with the description above. Accordingly, other implementations are within the scope of the following claims.

What is claimed is:

1. A method, comprising:
receiving input to select a portion of a document corresponding to an area of interest associated with a clipping;
identifying a structural element associated with the portion;
determining a boundary associated with the structural element; and
triggering a visual impression indicating the structural element.

2. The method of claim 1, where triggering a visual impression indicating the structural element includes triggering a visual impression in proximity to the boundary.

3. The method of claim 2, further comprising:
receiving input to adjust a size of the boundary,
wherein triggering a visual impression in proximity to the boundary includes triggering the visual impression in proximity to the adjusted boundary.

4. The method of claim 1, further comprising:
receiving further input and responsive thereto removing the visual impression indicating the structural element;
receiving input to select another structural element in the document; and
displaying the another structural element with the visual impression.

5. The method of claim 1, wherein triggering a visual impression indicating the structural element includes highlighting the structural element.

6. A method, comprising:
providing a user interface for presentation on a display device, the user interface including a display area for display content;
identifying one or more structural elements in the content displayed in the display area, at least one structural element being associated with a potential area of interest; and
displaying the identified structural elements with a visual impression.

7. The method of claim 6, further comprising:
displaying a cursor in the display area; and
identifying a region occupied by an identified structural element,
wherein displaying the one or more identified structural elements with a visual impression includes triggering the visual impression only when the cursor is bound within the region.

8. The method of claim 6, further comprising:
displaying a cursor in the display area;
determining a first parameter associated with the cursor; and
identifying a second parameter associated with at least one identified structural element,
the method further comprising:
comparing the first parameter with the second parameter,
wherein displaying the identified structural elements with a visual impression includes displaying the at least one identified structural element with a visual impression only if the first parameter corresponds or in proximity to the second parameter.

9. The method of claim 8, wherein the first parameter includes a coordinate position of the cursor, and the second parameter includes a coordinate position and extent including a boundary of the at least one identified structural element.

10. The method of claim 9, wherein an identified structural element is displayed with a visual impression only when the coordinate position of the cursor is bound within the extent of the identified structural element.

11. The method of claim 6, wherein identifying one or more structural elements in the content includes:
parsing the content source to determine one or more elements having a corresponding layout structure in the content source.

12. The method of claim 6, wherein displaying the identified structural elements with a visual impression includes highlighting the identified structural elements.

13. The method of claim 6, further comprising:
displaying a cursor in the display area,
wherein displaying the identified structural elements with a visual impression includes:
tracking a position of the cursor;
comparing the position of the cursor to position of the identified structural elements on the display screen; and
displaying a corresponding identified structural element in proximity to the cursor based on the comparison.

14. A method, comprising:
identifying a content source;
identifying one or more elements in the content source, the one or more elements having a corresponding structure in the content source;
determining one or more potential areas of interest based on the one or more identified elements, the one or more potential areas being displayed in a display area;
identifying a boundary for each of the one or more potential areas of interest;
presenting the one or more potential areas of interest; and
triggering a visual effect in proximity to the boundary based on a predetermined criteria.

15. The method of claim 14, further comprising:
displaying a cursor in the display area,
wherein identifying one or more structural elements in the content displayed in the display area includes identifying a default structural element associated with a location of the cursor based on one or more criteria, and
wherein displaying the identified structural elements with a visual impression includes displaying only the default structural element with the visual impression.

16. The method of claim 14, wherein the one or more criteria include a distance between a structural element and a location of the cursor, and a boundary size of a boundary of a structural element.

17. The method of claim 14, further comprising displaying a cursor in the display area;
displaying a visual indicator for each identified structural element; and
receiving input to select a structural element using the cursor,
wherein displaying the identified structural element with a visual impression includes displaying only the structural element corresponding to the selected visual indicator with the visual impression.

18. A computer program product, encoded on a computer-readable medium, operable to cause a data processing apparatus to:
receive input to select a portion of a document corresponding to an area of interest associated with a clipping;
identify a structural element associated with the portion;
determine a boundary associated with the structural element; and
trigger a visual impression indicating the structural element.

19. A computer program product, encoded on a computer-readable medium, operable to cause a data processing apparatus to:
provide a user interface for presentation on a display device, the user interface including a display area for display content;
identify one or more structural elements in the content displayed in the display area, at least one structural element being associated with a potential area of interest; and
display the identified structural elements with a visual impression.

20. A computer program product, encoded on a computer-readable medium, operable to cause a data processing apparatus to:
identify a content source;
identify one or more elements in the content source, the one or more elements having a corresponding structure in the content source;
determine one or more potential areas of interest based on the one or more identified elements, the one or more potential areas being displayed in a display area;
identify a boundary for each of the one or more potential areas of interest;
present the one or more potential areas of interest; and
trigger a visual effect in proximity to the boundary based on a predetermined criteria.

21. A system comprising:
means for receiving input to select a portion of a document corresponding to an area of interest associated with a clipping;
means for identifying a structural element associated with the portion;
means for determining a boundary associated with the structural element; and
means for triggering a visual impression indicating the structural element.

22. A system comprising:
means for providing a user interface for presentation on a display device, the user interface including a display area for display content;
means for identifying one or more structural elements in the content displayed in the display area, at least one structural element being associated with a potential area of interest; and
means for displaying the identified structural elements with a visual impression.

23. A system comprising:
means for identifying a content source;
means for identifying one or more elements in the content source, the one or more elements having a corresponding structure in the content source;
means for determining one or more potential areas of interest based on the one or more identified elements, the one or more potential areas being displayed in a display area;
means for identifying a boundary for each of the one or more potential areas of interest;
means for presenting the one or more potential areas of interest; and
means for triggering a visual effect in proximity to the boundary based on a predetermined criteria.
